(19) United States
(12) Patent Application Publication
(10) Pub. No.: US 2007/0220774 A1
(43) Pub. Date: Sep. 27, 2007

(54) Hair dryer

(76) Inventor: Jung Hyun Shin, Gyeonggi-Do (KR)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 11/408,977

(22) Filed: Apr. 24, 2006

(30) Foreign Application Priority Data
Mar. 21, 2006 (KR) 2006-0025832

(51) Int. Cl. A45D 20/12; C04B 37/02

(52) U.S. Cl. 34/96; 403/179

(57) ABSTRACT

Disclosed is a hair dryer used for hair treatment such as permanent wave or drying. The hair dryer includes a main unit including a hollow housing and a handle perpendicularly coupled to the lower portion of the housing, which is generally formed in shape of pistol, the housing having an air outlet and an air inlet, each of which is disposed at front and rear sides of the housing, and a blowing element and an electric heating element disposed in series between the air outlet and the air inlet, and an auxiliary unit including a housing having an air outlet and an air inlet, each of which is disposed at front and rear sides of the auxiliary housing, and a blowing element and an electric heating element disposed in series between the air outlet and the air inlet. The auxiliary unit is selectively and detachably mounted around the housing of the main unit, and at least one auxiliary unit is disposed in parallel with the housing of the main unit. The main unit and the auxiliary unit are provided with at least one coupling member for detachably coupling the units.

### BACKGROUND OF THE INVENTION

1. Field of the Invention

The present invention relates to a hair dryer used for hair treatment such as permanent wave or drying, and more particularly, to a hair dryer in which at least one auxiliary unit can be selectively coupled to a main unit.

1. Background of the Related Art

Several hair dryers used for hair treatment such as permanent wave or drying have been developed and utilized up to date. Such a hair dryer includes a hollow housing and a handle perpendicularly coupled to the housing, which is generally formed in the shape of pistol.

More specifically, the housing includes an air inlet and an air outlet disposed at front and rear sides of the housing, and a blowing element and a heating element disposed in series between the air inlet and the air outlet. When a switch installed to a proper portion of the handle or housing is operated, the electric power is applied to the hair dryer, the blowing element is driven, and simultaneously air is sucked into the housing thorough the air inlet from the exterior. The air is heated by the heating element, while the air is passing through the heating element. At this time, after the air is converted into a hot air stream having proper temperature to treat the hair, the air is blown on the hair of a user through the air outlet, thereby treating the hair.

The hair dryer is generally gripped by a user's hand to treat the hair, and the hair dryer is available for a common user since a volume, capacity, and weight of the hair dryer are designed to be suitable for the common user. Therefore, the specification of the hair dryer is limited, and thus its capacity is hardly increased.

In order to shorten a hair treating time or increase a hair treating efficiency in a shop making a business of cosmetic treatment such as a beauty salon, however, it is needed for an increased capacity of the hair dryer. A hairdresser gets the hair of a customer style at the beauty salon, with the hairdresser holding two units simultaneously, since a proper hair treating unit is not popularized. Also, the overweight affects a human body, which may injure the articulation of the hairdresser working for a long time.

### SUMMARY OF THE INVENTION

Accordingly, the present invention is directed to a hair dryer that substantially obviates one or more problems due to limitations and disadvantages of the related art.

An object of the present invention is to provide a hair dryer in which at least one auxiliary unit can be selectively coupled to a main unit, so that the hair dryer is stably gripped, thereby preventing overstrain of a user's articulator and improving an operation efficiency.

Another object of the present invention is to provide a hair dryer adapted to easily increase or decrease an air flow rate according to treatment of hair and enhance a maximum level of the air flow rate, thereby improving an efficiency of hair treatment.

To achieve the object and other advantages, according to one aspect of the present invention, there is provided a hair dryer comprising: a main unit including a hollow housing and a handle perpendicularly coupled to a lower portion of the housing, which is generally formed in shape of pistol, the housing having an air outlet and an air inlet, each of which is disposed at front and rear sides of the housing, and a blowing element and an electric heating element disposed in series between the air outlet and the air inlet; and an auxiliary unit including a housing having an air outlet and an air inlet, each of which is disposed at front and rear sides of the auxiliary housing, and a blowing element and an electric heating element disposed in series between the air outlet and the air inlet; in which the auxiliary unit is selectively and detachably mounted around the housing of the main unit, and at least one auxiliary unit is disposed in parallel with the housing of the main unit, and the main unit and the auxiliary unit are provided with at least one coupling member for detachably coupling the units.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a front view of a hair dryer according to the present invention;

FIG. 2 is a partially cross-sectional view taken along a line A-A in FIG. 1; and

FIG. 3 is a cross-sectional view illustrating the structure for coupling auxiliary units to a main unit in a hair dryer according to the present invention.

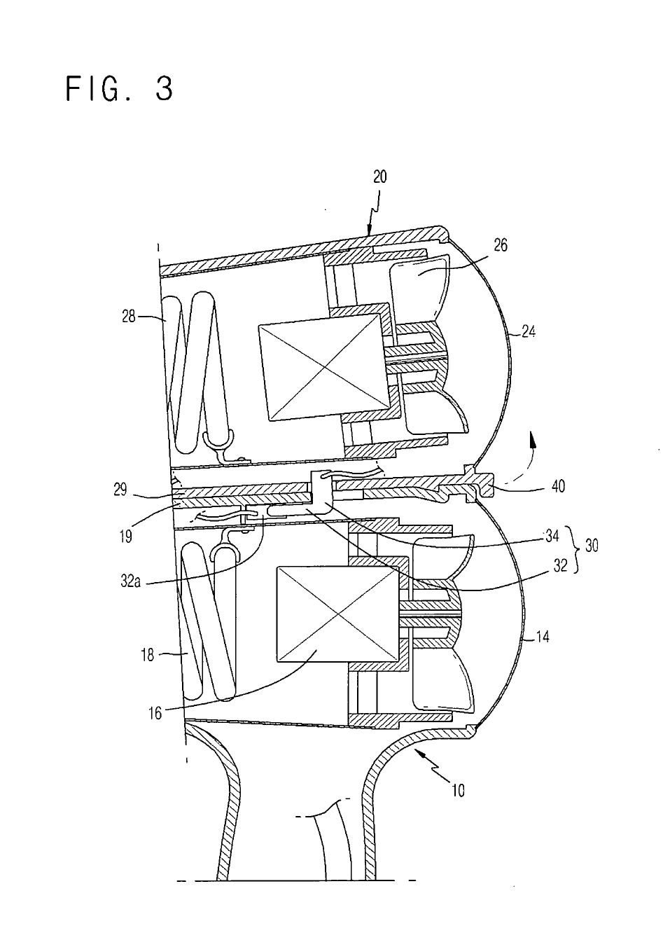

### DETAILED DESCRIPTION OF THE PREFERRED EMBODIMENTS

A preferred embodiment according to the present invention will now be explained with reference to the accompanying drawings.

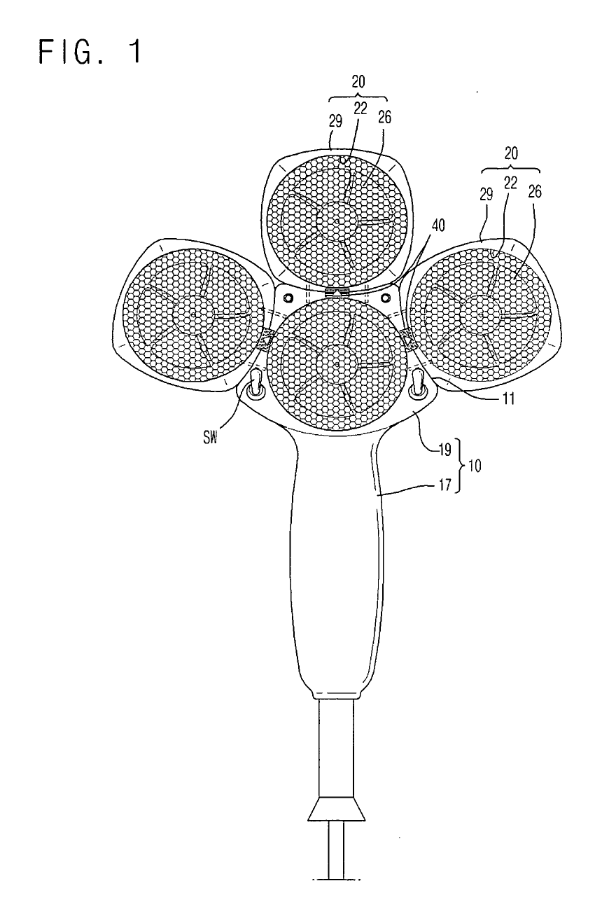

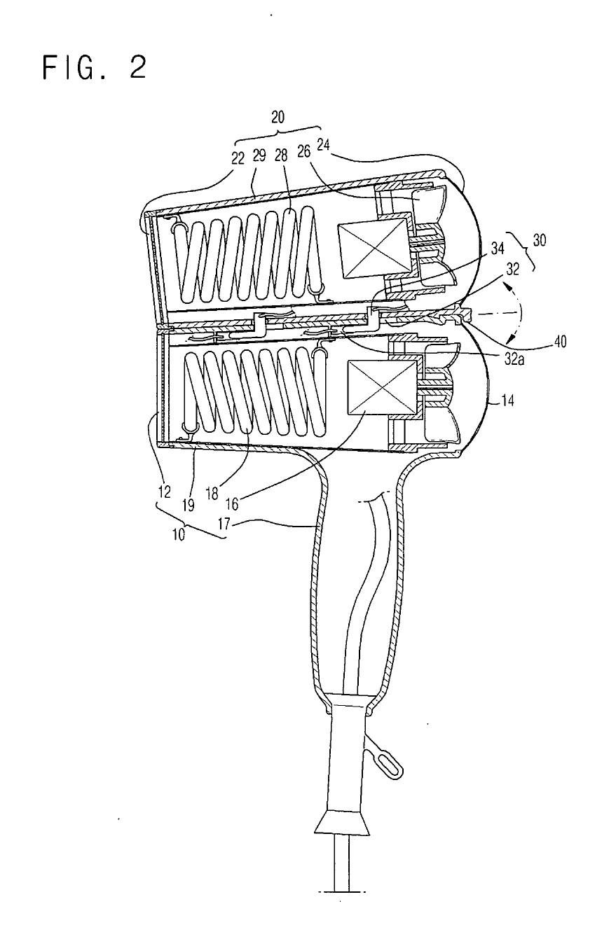

FIGS. 1 and 2 show a hair dryer according to the present invention in detail.

The hair dryer according to the present invention mainly includes a main unit 10 and at least one auxiliary unit 20.

The main unit 10 includes a hollow housing 19 and a handle 17 perpendicularly coupled to the lower portion of the housing 19, which is generally formed in the shape of pistol. The housing 19 has an air outlet 12 and an air inlet 14 and an air outlet, each of which is disposed at front and rear sides of the housing, and a blowing element 16 and an electric heating element 18 disposed in series between the air outlet 12 and the air inlet 14.

The auxiliary unit 20 includes a housing 29 having an air outlet 22 and an air inlet 24, each of which is disposed at front and rear sides of the auxiliary housing, and a blowing element 26 and an electric heating element 28 disposed in series between the air outlet 22 and the air inlet 24. The auxiliary unit 20 may be detachably mounted around the housing 19 of the main unit 1 0, and at least one auxiliary unit 20 may be disposed in parallel with the housing 19 of the main unit.

Only the main unit 10 is utilized to treat the hair, for example, permanent wave, while in case of drying wet hair, the auxiliary units 20 may be selectively mounted on the main unit 10 to obtain a desired level of air flow rate, if necessary.

The main unit 10 and the auxiliary unit 20 are provided with at least one coupling member 30 for detachably coupling the units 10 and 20 at opposite surfaces thereof The coupling member has a female receiving portion 32 and a male locking portion 34 which are snap-engaged to each other. The coupling member 30 can electrically connect the main unit 10 and the auxiliary unit 20 via a connection terminal 32a provided in the female receiving portion 32.

When the main unit 10 and the auxiliary unit 20 are coupled to each other by the coupling member 30, the coupling state thereof is maintained by a resilient snap element 40 provided at a proper position between the main unit 10 and the auxiliary unit 20.

The housing 19 of the main unit 10 is provided on a wall thereof with a seating element 11 for receiving the housing 29 of the auxiliary unit 20 in a longitudinal direction of the housing 19 and stably coupling the housing 29 to the housing 19.

According to the hair dryer of the present invention, switches for controlling the operation are disposed not at the handle 19, but at a front portion of the housing 19 of the main unit 10. Therefore, it can prevent a hand of the user from being damaged by the switches provided to a conventional handle.

As the above description, at least one auxiliary unit can be selectively coupled to the main unit, so that the hair dryer is stably gripped by a user, thereby preventing overstrain of a user's articulator and improving an operation efficiency.

Also, the hair dryer is adapted to easily increase or decrease an air flow rate according to treatment of the hair and enhance a maximum level of the air flow rate, thereby improving an efficiency of hair treatment.

The forgoing embodiment is merely exemplary and is not to be construed as limiting the present invention. The present teachings can be readily applied to other types of apparatus. The description of the present invention is intended to be illustrative, and not to limit the scope of the claims. Many alternatives, modifications, and variations will be apparent to those skilled in the art.

What is claimed is:

1. A hair dryer comprising:
a main unit including a hollow housing and a handle perpendicularly coupled to a lower portion of the housing, which is generally formed in shape of pistol, the housing having an air outlet and an air inlet, each of which is disposed at front and rear sides of the housing, and a blowing element and an electric heating element disposed in series between the air outlet and the air inlet; and
an auxiliary unit including a housing having an air outlet and an air inlet, each of which is disposed at front and rear sides of the auxiliary housing, and a blowing element and an electric heating element disposed in series between the air outlet and the air inlet;
in which the auxiliary unit is selectively and detachably mounted around the housing of the main unit, and at least one auxiliary unit is disposed in parallel with the housing of the main unit, and
the main unit and the auxiliary unit are provided with at least one coupling member for detachably coupling the units.

2. The hair dryer as claimed in claim 1, wherein the coupling member has a female element and a male element for coupling the auxiliary unit to the main unit at an opposite surface thereof.

3. The hair dryer as claimed in claim 2, wherein the coupling member is adapted to electrically connect the auxiliary unit and the main unit.

4. The hair dryer as claimed in claim 1, wherein a coupling state between the main unit and the auxiliary unit is maintained by a resilient snap element provided at a proper position between the main unit and the auxiliary unit.

5. The hair dryer as claimed in claim 1, wherein the housing of the main unit is provided on a wall thereof with a seating element for receiving the housing of the auxiliary unit in a longitudinal direction of the housing and stably coupling the housing to the housing.
